(19) United States
(12) Patent Application Publication
(10) Pub. No.: US 2009/0021604 A1
(43) Pub. Date: Jan. 22, 2009

(54) Device for recording customers' AV data to be accessed and seen by hairdresser

(76) Inventors: Chin ping Tseng, Taipei (TW); Chin Chin Tseng, Taipei (TW)

Correspondence Address: SAM CHEN, 7F-1, 293, ROOSEVELT ROAD, SEC 3, TAIPEI, TW

(21) Appl. No.: 11/781,059

(22) Filed: Jul. 20, 2007

(51) Int. Cl. H04N 5/76

(52) U.S. Cl. 348/231.9; 348/E05.024

(57) ABSTRACT

A device for recording customers' AV data including for example, preferential styles of the customers is disclosed. Prior to serving a seated customer, a hairdresser can access AV data of the customer by inserting a memory card into the device and then visually observe it.

### BACKGROUND OF THE INVENTION

1. Field of Invention

The invention relates to data recording and accessing and more particularly to a device for recording customers' AV (audio video) data including preferential styles of the customers so that a hairdresser can access it and visually observe it when a customer comes to the hair salon for hairdressing.

2. Description of Related Art

Conventionally, a hairdresser has to talk with a customer prior to and/or during service so as to perform quality hairdressing to the customer. However, this is relatively time consuming. Moreover, it may be difficult and/or insufficient by simply making a short conversation between a hairdresser and a customer if a complicated style is to be done on the customer. Thus, a need for improvement exists.

### SUMMARY OF THE INVENTION

It is therefore one object of the invention to provide a device for recording customers' AV data including for example, preferential styles of the customers so that a hairdresser can access it and visually observe it when a customer comes to the hair salon for hairdressing.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of AV data recording device for hairdresser according to the invention;

FIG. 2 schematically depicts components of the AV data recording and transmitting assembly of FIG. 1;

FIG. 3 schematically depicts connections of the components of the AV data recording and transmitting assembly of FIG. 2;

FIG. 4 further schematically depicts connections of the components of the AV data recording and transmitting assembly of FIG. 3; and

FIG. 5 schematically depicts connections of the components of the AV data receiving assembly of FIG. 1.

### DETAILED DESCRIPTION OF THE INVENTION

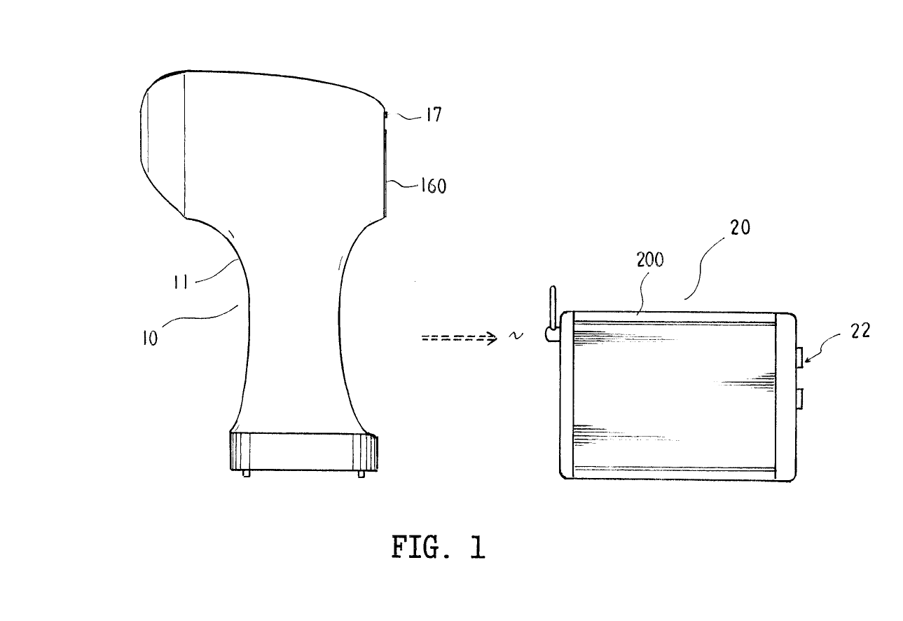

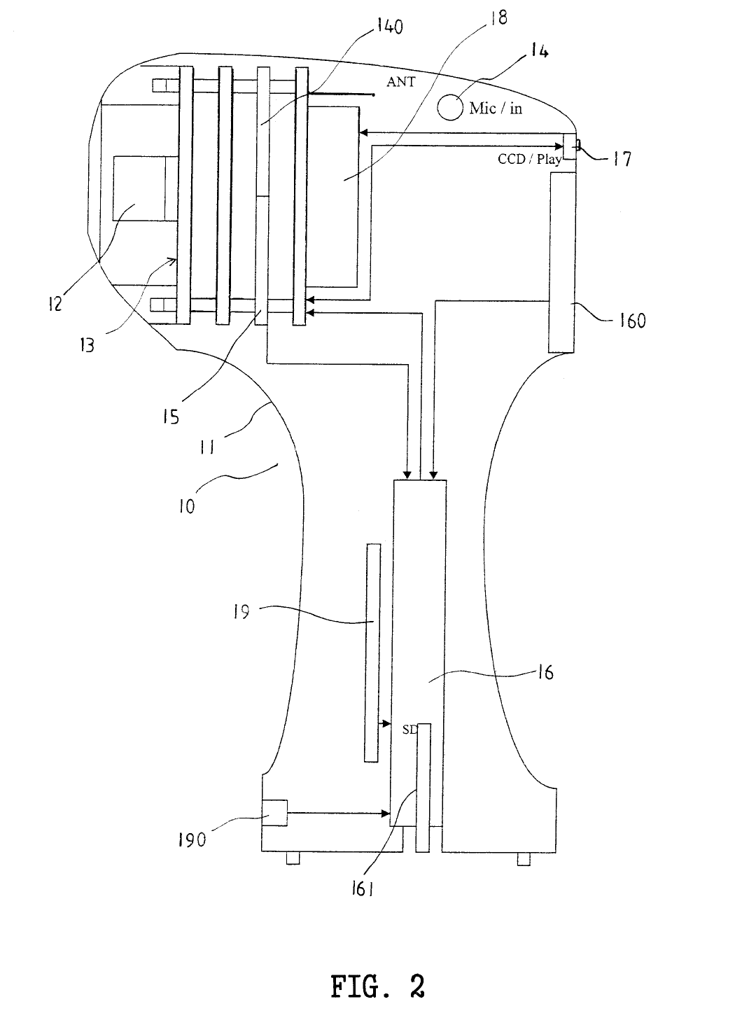

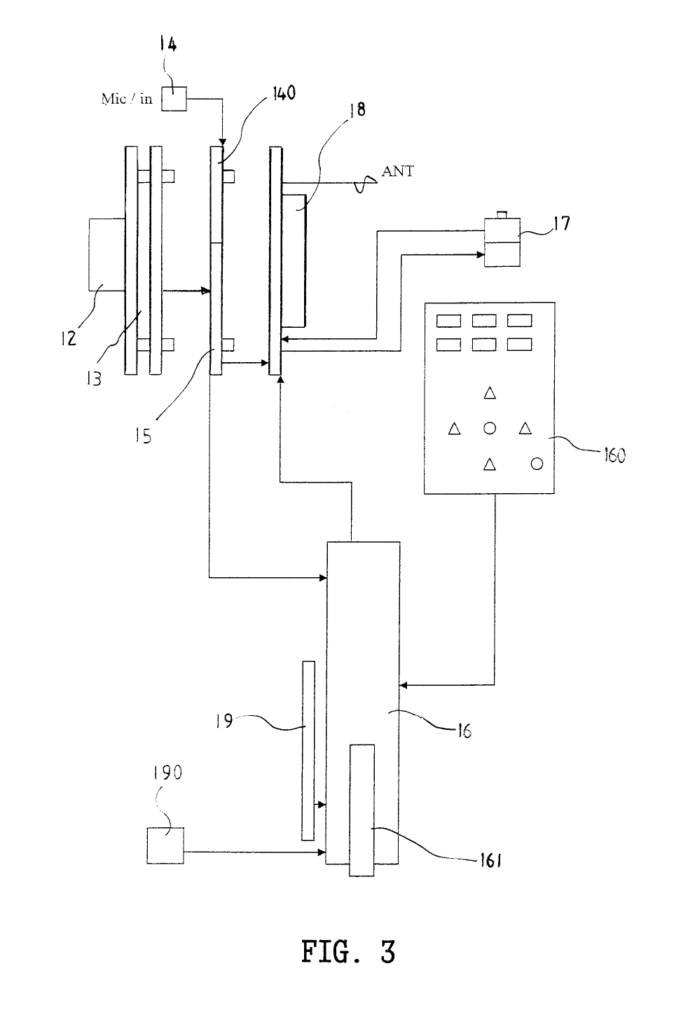

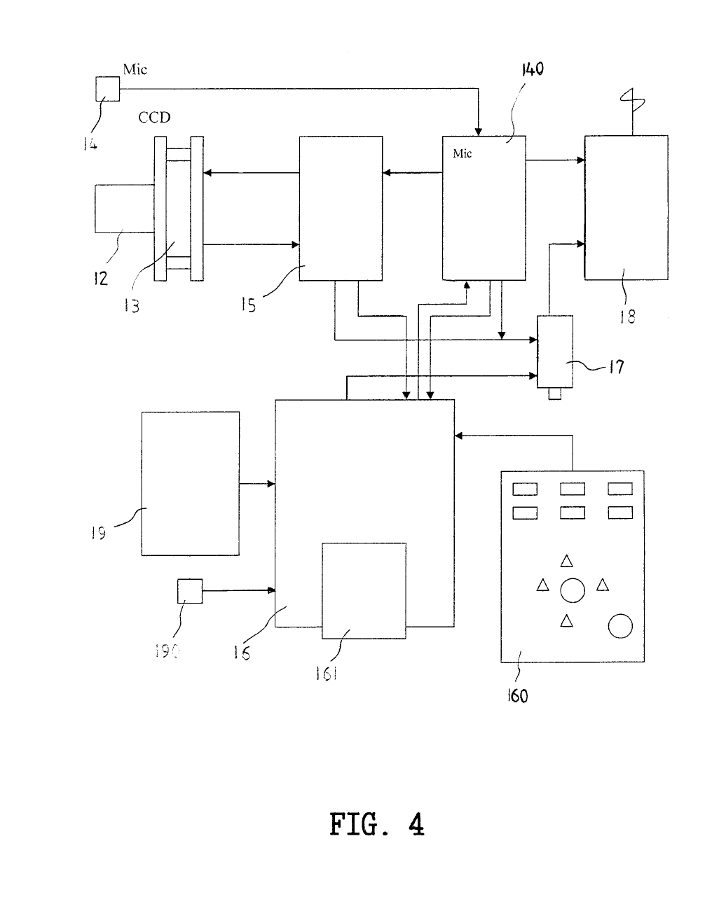

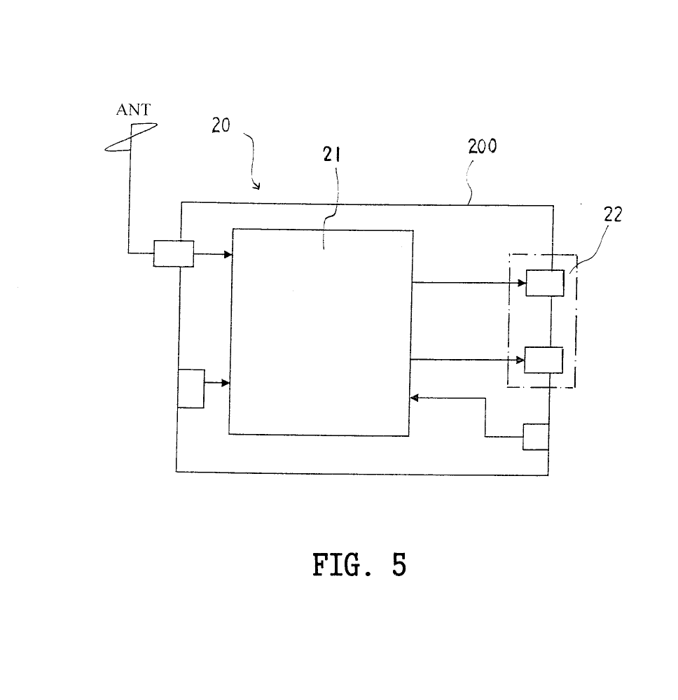

Referring to FIGS. 1 to 5, a device used by a hairdresser according to a preferred embodiment of the invention comprises an AV data recording and transmitting assembly 10 and an AV data receiving assembly 20. The AV data recording and transmitting assembly 10 comprises a housing 11 shaped to be held by the hand. Within the housing 11 there are provided a camera module 13 having a lens 12, a microphone 14, a distributor 15 electrically connected to the camera module 13, an audio amplifier 140 electrically interconnected the microphone 14 and the distributor 15, a data recording unit 16 electrically connected to the distributor 15 and the audio amplifier 140 respectively, a panel 160 for controlling the data recording unit 16, a signal switch 17 electrically connected to the distributor 15, the audio amplifier 140 and the data recording unit 16 respectively, and an AV signal transmitter 18 electrically connected to the signal switch 17 and having an antenna (not numbered).

The AV data receiving assembly 20 comprises a housing 200 having an internal AV data receiving unit 21, an extending antenna (not numbered), and ports 22 provided on the surface and electrically connected to the AV data receiving unit 21. The camera module 13 is adapted to take pictures of a customer and convert same into video signals. The microphone 14 in cooperation with the audio amplifier 140 is adapted to amplify the voice of the customer. The distributor 15 is adapted to output video signals to the AV signal transmitter 18, and the audio amplifier 140 is adapted to output audio signals to the AV signal transmitter 18 respectively. The signal switch 17 is adapted to set to cause the AV signal transmitter 18 to transmit signals to the AV data receiving unit 21. The AV data receiving unit 21 then sends the received signals to the ports 22 for output.

The distributor 15 is adapted to selectively output video signals. A hairdresser can manipulate the panel 160 to activate the data recording unit 16 to store audio and video signals of a customer in its memory card. The hairdresser can further manipulate the signal switch 17 to cause the panel 160 to control the data recording unit 16. Thus, the AV signal transmitter 18 is adapted to transmit the stored audio and video signals to the AV data receiving unit 21. The AV data receiving unit 21 then sends the received signals to the ports 22 for output (e.g., to an audio video (AV) player). The memory card of the data recording unit 16 is removable. Also, records of many different customers can be stored in the memory card. Hence, a hairdresser can immediately know the preferential style and other useful information of a specific customer by inserting a specific memory card in the data recording unit 16 and reading same.

The AV data recording and transmitting assembly 10 further comprises a rechargeable battery 19 for supplying working current to the device, and a power socket 190 such that a power cord can be used to interconnect the power socket 190 and a wall outlet for feeding an external AC power to the device.

The data recording unit 16 comprises a slot 161 for allowing an SD card to insert thereinto. Data about a specific customer can be stored in the SD card prior to inserting into the slot 161 for reading or writing.

While the invention herein disclosed has been described by means of specific embodiments, numerous modifications and variations could be made thereto by those skilled in the art without departing from the scope and spirit of the invention set forth in the claims.

What is claimed is:

1. A device used by a hairdresser in serving a customer comprising:
an AV (audio video) data recording and transmitting assembly comprising a camera, a microphone, a distributor electrically connected to the camera, an audio amplifier electrically interconnected the microphone and the distributor, a data recording unit electrically connected to the distributor and having a slot for removably receiving a memory card, a panel for controlling the data recording unit, a signal switch, and an AV signal transmitter having a first antenna and electrically connected to the signal switch, the distributor, and the data recording unit respectively; and
an AV data receiving assembly comprising a second antenna, an AV data receiving unit, and ports electrically connected to the AV data receiving unit,
wherein the camera is adapted to take pictures of a seated customer and convert the taken pictures into video signals, the microphone in cooperation with the audio amplifier is adapted to amplify voice of the customer, the distributor is adapted to send the video signals to the AV signal transmitter, the audio amplifier is adapted to send audio signals representing the voice of the customer to the AV signal transmitter, the signal switch is adapted to set to cause the AV signal transmitter to transmit the audio and video signals to the AV data receiving unit via the first antenna, and the AV data receiving unit is adapted to receive the audio and video signals via the second antenna prior to sending the received audio and video signals to a display unit for display via the ports; and
wherein the panel is adapted to manipulate to activate the data recording unit to store the audio and video signals in a memory card placed in the slot.

2. The device of claim 1, wherein the AV data recording and transmitting assembly further comprises a rechargeable battery electrically connected to the data recording unit.
